(19) United States
(12) Patent Application Publication
(10) Pub. No.: US 2024/0134129 A1
(43) Pub. Date: Apr. 25, 2024

(54) ASSEMBLIES, OPTICAL CONNECTORS AND METHODS OF BONDING OPTICAL FIBERS TO SUBSTRATES USING A LASER BEAM AND ELECTROPLATING

(71) Applicant: CORNING RESEARCH & DEVELOPMENT CORPORATION, CORNING, NY (US)

(72) Inventors: Leonard Charles Dabich, II, Painted Post, NY (US); Mark Alejandro Quesada, Horseheads, NY (US)

(21) Appl. No.: 18/390,016

(22) Filed: Dec. 20, 2023

Related U.S. Application Data
(63) Continuation of application No. PCT/US2022/032475, filed on Jun. 7, 2022.
(60) Provisional application No. 63/214,877, filed on Jun. 25, 2021.

(51) Int. Cl. G02B 6/36

(52) U.S. Cl. CPC G02B 6/3672; G02B 6/3684

(57) ABSTRACT

Assemblies and optical connectors including one or more optical fibers laser-bonded to a substrate, as well as methods for fabricating the same, are disclosed. In one embodiment, an assembly includes a substrate having a surface, an optical element bonded to the surface of the substrate, a bond area between the optical fiber and the surface of the substrate, wherein the bond area includes laser-melted material of the substrate that bonds the optical fiber to the substrate, and a metal buttress structure adjacent to the bond area.

### PRIORITY APPLICATION

This application is a continuation of International Application No. PCT/US2022/032475 filed Jun. 7, 2022, which claims the benefit of priority of U.S. Provisional Application No. 63/214,877, filed on Jun. 25, 2021, the content of which is relied upon and incorporated herein by reference in its entirety.

### BACKGROUND

The present disclosure generally relates to methods for securing optical fibers to substrates and, more particularly methods for bonding optical fibers to substrates using a laser beam and electroplating, and optical connectors and assemblies comprising optical fibers bonded to substrates using a laser beam and electroplated buttress structures.

Benefits of optical fiber include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between an optical cable assembly and an electronic device.

Optical connectors may include optical fibers secured to a substrate. Typically, the optical fibers are secured to the substrate using an adhesive, which have a high coefficient of thermal expansion (CTE). The optical connectors may then be connected to another optical device to provide optical communication between optical devices. In one example, the optical connector is connected to an edge of a waveguide substrate having waveguides providing optical channels. The waveguide substrate may be a component of a photonic integrated circuit assembly, for example. In some cases, the connected optical connector and the optical device may be subjected to elevated temperatures, such as during a solder reflow process. The high CTE adhesive may cause the position of the optical fibers to shift due to the elevated temperatures and become misaligned with the optical channels of the optical device. The shifting of the optical fibers may prevent optical signals from passing between the optical connector and the optical device.

Bonding an optical fiber to a substrate by laser welding has also been shown to be a viable bonding method that minimizes thermally induced stress. However, because the laser weld is a narrow line under the optical fiber, torque applied to the optical fibers may cause failure in the bond between the optical fiber and the substrate. Thermal cycling is a source of force that may induce the torque on the optical fibers leading to bond failure.

### SUMMARY

Embodiments of the present disclosure are directed to methods for bonding one or more optical fibers (or other optical elements) to a substrate using a laser beam, as well as optical connectors and/or assemblies resulting from said methods. Particularly, the optical fiber acts as a cylindrical lens to focus the laser beam into the substrate, or into a thin interfacial coating on the substrate that absorbs at least 20% incident laser energy. The focused laser beam melts the substrate material, which also causes the melted substrate material to migrate into the material of the optical fiber, and bonding. The focused laser beam energy can also be absorbed by a thin absorbing film deposited on the glass substrate, melting the film, melting the substrate material, which also causes the melted substrate material to migrate into the material of the optical fiber, and bonding. Thus, the optical fiber is bonded to the substrate using a laser welding process. The cylindrical lens provided by the optical fiber may eliminate the need to have a complicated optical delivery system to locally focus the laser beam into the substrate material. An electroplating step following the laser beam step creates a buttress structure along the bonding area that reduces a torque applied to the optical fiber, thereby providing a more robust bond. Optical connectors and assemblies comprising one or more optical fibers bonded to a substrate using a laser beam are also disclosed.

In this regard, in one embodiment, an assembly includes a substrate having a surface, an optical element bonded to the surface of the substrate, a bond area between the optical element and the surface of the substrate, wherein the bond area includes laser-melted material of the substrate that bonds the optical element to the substrate, and a metal buttress structure adjacent to the bond area and the optical element.

In another embodiment, a fiber optic connector includes a housing, a substrate disposed within the housing, a film layer disposed on the substrate; an array of optical fibers bonded to a surface of the substrate, a bond area between each optical fiber of the array of optical fibers and the surface of the substrate, wherein the bond area includes laser-melted material of at least one of the substrate and the film layer that bonds the optical fiber to the substrate, and a metal buttress structure adjacent to each bond area and each optical fiber of the array of optical fibers.

In yet another embodiment, a method of bonding an optical element to a substrate includes disposing a film layer on a surface of the substrate, disposing the optical element on a surface of the film layer, directing a laser beam into the optical element, and melting a material of the substrate with the laser beam that was directed into the optical element to create a bond area between the optical element and the surface of the substrate, wherein the film layer is capable of absorbing a wavelength of the laser beam to melt the material of the substrate at the bond area, and wherein the bond area includes laser-melted material of the substrate that bonds the optical element to the substrate. The method further includes electroplating a metal buttress structure adjacent to the optical element.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a perspective view of an assembly comprising a plurality of optical fibers bonded to a substrate by a laser welding process according to one or more embodiments described and illustrated herein;

FIG. 2 schematically depicts an end view of an optical fiber positioned on a film layer disposed on a surface of a substrate according to one or more embodiments described and illustrated herein;

FIG. 3 schematically depicts ray tracing of light of a laser beam focused by the optical fiber depicted by FIG. 2 according to one or more embodiments described and illustrated herein;

FIG. 4 schematically depicts the optical fiber bonded to the substrate depicted by FIG. 2 using a laser beam according to one or more embodiments described and illustrated herein;

FIG. 5 schematically depicts a top down view of a plurality of optical fibers being bonded to a substrate by a plurality of passes of a laser beam according to one or more embodiments described and illustrated herein;

FIG. 6 is a microscope image of a plurality of optical fibers bonded to a substrate by multiple passes of a laser beam according to one or more embodiments described and illustrated herein;

FIG. 7 is a microscope image of a bond area of an optical fiber bonded to a substrate according to one or more embodiments described and illustrated herein;

FIG. 8 is a microscope image of broken optical fibers bonded to a substrate by a laser beam illustrating a strength of bond areas that bond the optical fibers to the substrate according to one or more embodiments described and illustrated herein;

FIG. 9 schematically depicts an end view of a fixture securing a plurality of optical fibers to a substrate prior to bonding the plurality of optical fibers to the substrate by a laser beam according to one or more embodiments described and illustrated herein;

FIG. 10 schematically depicts a top down view of the fixture, optical fibers and substrate depicted in FIG. 9 according to one or more embodiments described and illustrated herein;

FIG. 11 schematically depicts an example optical connector that includes optical fibers that are laser-bonded to a substrate according to one or more embodiments described and illustrated herein;

FIG. 12A is a scanning electron microscope (SEM) image of an optical fiber bonded to a substrate where there is a fracture present in a bond area;

FIG. 12B is a SEM image of an optical fiber bonded to a substrate where there is no fracture present in a bond area;

FIG. 13A is a digital image of a top-down view of a plurality of optical fibers bonded to a substrate according to one or more embodiments described and illustrated herein;

FIG. 13B is a close-up SEM image of the region 13B of FIG. 13A according to one or more embodiments described and illustrated herein;

FIG. 14 is a schematic illustration of ray traces through an optical fiber at three laser beam locations with respect to the optical fiber, and the laser beams impact on regions of a plurality of optical fibers bonded to a substrate according to one or more embodiments described and illustrated herein;

FIG. 15A is a schematic illustration of an example electroplating bath for electroplating buttress structures to a substrate having a plurality of optical fibers bonded thereto according to one or more embodiments described and illustrated herein;

FIG. 15B is a schematic illustration of applying an epoxy to secure a cover to a plurality of optical fibers bonded to a substrate according to one or more embodiments described and illustrated herein;

FIG. 15C is a schematic illustration of dicing an assembly including a plurality of optical fibers laser bonded to a substrate according to one or more embodiments described and illustrated herein;

FIG. 16 is a digital image of an end face of a diced assembly showing a plurality of optical fibers bonded to a substrate and buttress structures electroplated in regions near the optical fibers according to one or more embodiments described and illustrated herein;

FIG. 17A is a SEM image of an optical fiber laser bonded to a substrate without buttress structures;

FIG. 17B is a schematic illustration of a lever arm extending from a point of force applied to a point at an edge of contact between the optical fiber and a bond area;

FIG. 18A is a SEM image of an optical fiber laser bonded to a substrate with buttress structures electro plated adjacent to the bond area according to one or more embodiments described and illustrated herein;

FIG. 18B is a schematic illustration of a lever arm extending from the point of force applied to a point at an edge of contact between the optical fiber and a buttress structure according to one or more embodiments described and illustrated herein; and

FIG. 19 is a schematic view of the first and second buttress structures of FIG. 18A according to one or more embodiments described and illustrated herein.

### DETAILED DESCRIPTION

Embodiments described herein are directed to methods for bonding optical fibers and/or other optical elements to substrates using a laser beam as well as optical connectors and assemblies including optical fibers and/or other optical elements bonded to substrates using a laser beam. Embodiments of the present disclosure enable optical elements that have a curved shape (e.g., optical fibers) to be bonded to a flat substrate without the use of adhesives. Generally, adhesives have a high coefficient of thermal expansion (CTE). It may be desirable to subject an optical connector incorporating optical fibers secured to a substrate to a high temperature process, such as a solder reflow process. As an example and not a limitation, a connector may be attached to an optical assembly, such as an edge of a waveguide substrate of a photonic integrated circuit assembly. The photonic integrated circuit assembly and a main circuit board may be subjected to a solder reflow process after the connector is attached to a waveguide substrate of the photonic integrated circuit assembly. For effective optical communication between the optical connector and the optical channels of the photonic integrated circuit assembly (or other optical assembly), the optical fibers should be aligned to the optical channel of the photonic integrated circuit assembly with sub-micron accuracy. If adhesive is used to secure the optical fibers to the substrate of the optical connector, the elevated temperatures of the solder reflow process may cause expansion of the high-CTE adhesive. This may then cause the optical fibers to move, which can then cause the optical fibers to become misaligned with respect to the optical channels of the photonic integrated circuit assembly (or other optical assembly).

Embodiments of the present disclosure provide for a fixed pre-attachment procedure that does not rely on high-CTE adhesives and enables the optical fibers and substrate to be subjected to elevated temperatures, such as a solder reflow process. In embodiments, a laser beam is focused by the curved surface of the optical fiber such that a diameter of the laser beam is reduced at a contact area between the optical fiber and the substrate. A film layer may be provided on a surface of the substrate that absorbs the laser beam, causing the surface of the substrate to melt. The film layer may also be configured as or into a thin interfacial coating on the substrate that absorbs at least 20% incident laser energy. The material of the substrate diffuses into the material of the optical fiber, thereby causing the optical fiber to be bonded to the substrate. Thus, the embodiments described herein enable the bonding of geometrically different components (i.e., curved optical fibers to a flat substrate) using dissimilar materials (e.g., fused silica optical fibers and a glass substrates). As used herein, the term “melt” means that the material is modified by heating in any manner that bonds the optical fiber to the substrate, and includes, but is not limiting to, actual melting of the material as well as visco-elastic swelling of the material. Also, as used herein, the terms “radius” and “diameter” in connection with an optical fiber refer to dimensional characteristics from a geometric center of the optical fiber to an outer surface of the optical fiber.

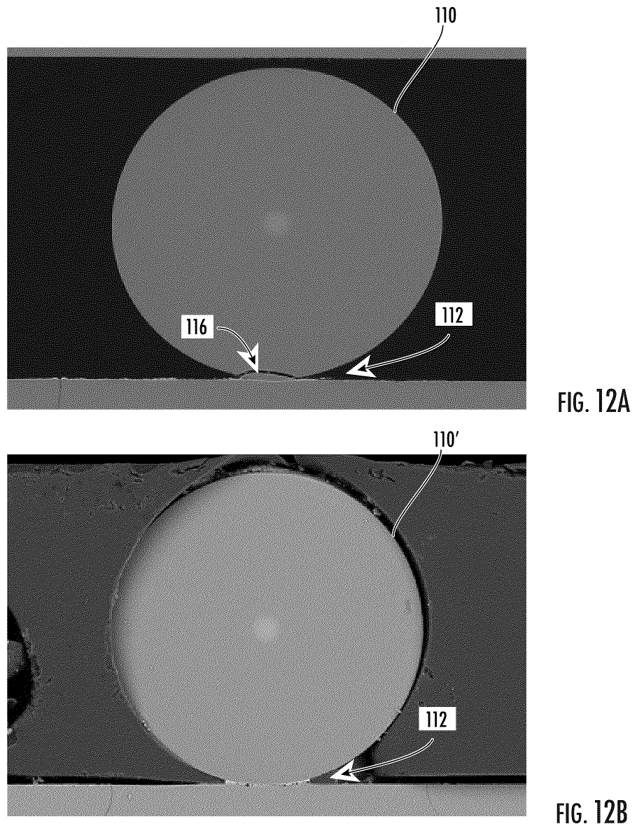

Although the laser bonding techniques described herein provide a strong bond between the optical fibers and the substrate, the optical fibers may still be prone to breaking off of the substrate when a force is applied to them. The likeliest fracture zones are directly at the edges of the weld (see FIG. 12). A likeliest cause of force applied to the optical fibers is the thermal-cycling between low temperatures (e.g., −40° C.) and high temperatures (e.g., 85° C.) due to the thermal-expansion of the cured epoxy used in the connector assembly package. Embodiments of the present disclosure provide for a buttress structure that abuts the laser bonding area to effectively buttress the optical fiber at its weakest link (the edges of the bonding area). The buttress structures described herein are fabricated from electroplating a metal or metal alloy on the substrate directly adjacent to the bonding area. The buttress structures may be fabricated from a material having a low coefficient of thermal expansion, thereby minimizing thermal-expansion impact.

Although embodiments describe the bonding of optical fibers to a substrate, embodiments are not limited thereto. Other optical elements may be bonded to a substrate such as, without limitation, lenses.

Various embodiments of methods for bonding optical fibers to substrates using a laser and an electroplating process, and assemblies comprising a plurality of optical fibers bonded to a substrate are described in detail herein.

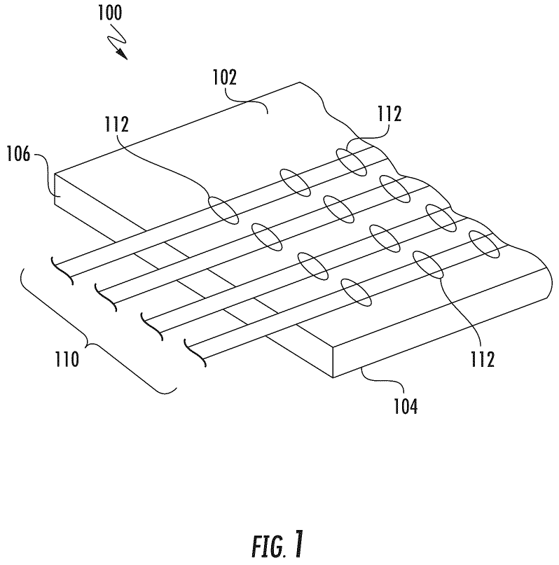

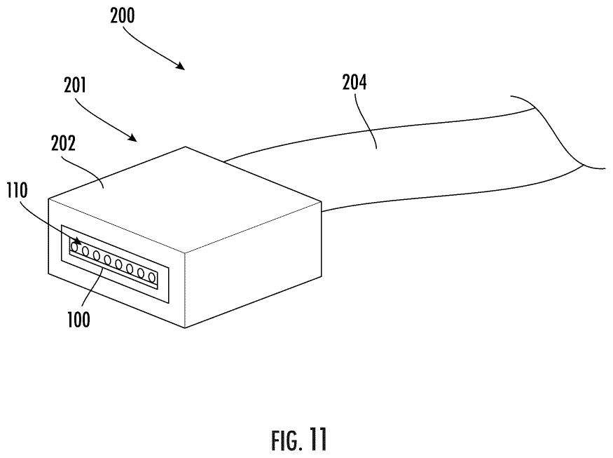

Referring now to FIG. 1, a partial perspective view of a substrate 100 with a plurality of optical fibers 110 bonded thereto is schematically depicted. As an example and not a limitation, the substrate 100 and the plurality of optical fibers 110 may be incorporated into a fiber optic connector. As an example and not a limitation, the substrate 100 and the plurality of optical fibers 110 may be incorporated into a fiber optic cable assembly 200, as illustrated schematically in FIG. 11. For example, the fiber optic cable assembly 200 may include a fiber optic connector 201 coupled to a fiber optic cable 204. The fiber optic connector 201 may include a housing 202. The substrate 100 (not shown in FIG. 11) and at least a portion of the optical fibers 110 may be located in the housing 402. It should be understood that embodiments described herein are not limited to fiber optic connectors, or fiber optic connectors of a particular type. The optical fiber and substrate assemblies may be incorporated into other optical devices.

The example substrate 100 depicted in FIG. 1 comprises a first surface 102, a second surface 104 opposite the first surface 102 and at least one edge 106 extending between the first surface 102 and the second surface 104. The substrate may be made of any low melting temperature material capable of diffusing into the material of the optical fiber 110. Generally, the melting temperature of the substrate 100 should be lower than the melting temperature of the optical fiber. An example non-limiting material for the optical fiber 110 is fused silica. Example materials for the substrate include, but are not limited to, glass, fused silica, and silicon. Non-limiting glass materials include alkaline earth boro-aluminosilicate glass (e.g., as manufactured and sold under the trade name Eagle XG® by Corning Incorporated of Corning, New York) and alkali-aluminosilicate glass (e.g., as manufactured and sold under the trade name Gorilla® Glass). As non-limiting examples, the softening point for Eagle XG® is about 970° C. Other non-limiting examples of glass include BK7 glass, soda lime and other glasses with flat or polished surfaces. For such glasses, the softening point may be within a range of about 650° C. to about 800° C., including endpoints. The softening point for fused silica is about 1715° C., so any glass with softening point less than 1500-1600° C. may be acceptable. It should be understood that the substrate 100 may be made of other low-melting temperature materials.

The thickness of the substrate 100 is not limited by this disclosure. The thickness of the substrate 100 may be any thickness as desired for the end-application of the optical fiber 110 and substrate 100 assembly.

The plurality of optical fibers 110 are bonded to the first surface 102 of the substrate 100 by one or more laser bonding processes as described in detail below. The optical fibers 110 are stripped of any jacket or outer layers to remove high CTE material. Although FIG. 1 depicts four optical fibers 110, it should be understood that any number of optical fibers 110 may be bonded to a surface of the substrate 100 (i.e., one or more optical fibers 110). It should also be understood that the optical fibers 110 may be bonded to the second surface 104, or both the first surface 102 and the second surface 104.

The optical fibers 110 may be fabricated from any material having a higher melting temperature than that of the substrate 100. As noted above, the optical fibers 110 may be fabricated from fused silica. The optical fibers 110 have a round shape in cross section. However, the optical fibers 110 may be elliptical in shape. As described in more detail below, the optical fibers 110 should have curved surfaces that focus a laser beam such that a size (e.g., a diameter) of the laser beam at the contact area between the optical fiber 110 and the first surface 102 of the substrate 100 is smaller than a size of the laser beam as it enters the optical fiber 110.

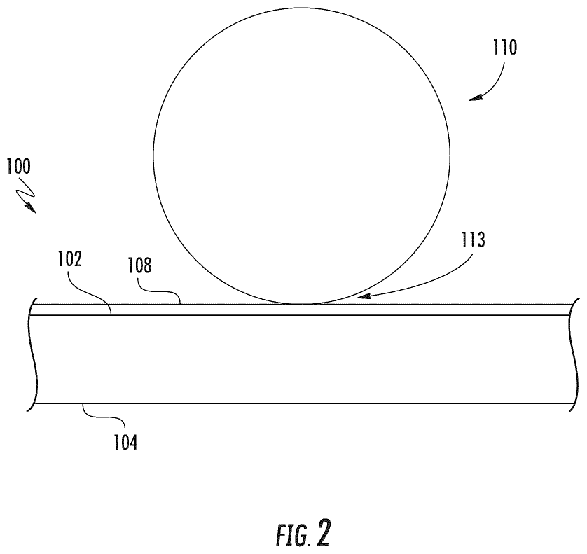

Each optical fiber 110 is bonded to the first surface 102 of the substrate 100 at one or more bond areas 112 along the length of the optical fiber 110. It is noted that the bond areas 112 are denoted by ellipses in FIG. 1. As described in detail below, the bond areas 112 are regions of the first surface 102 of the substrate 100 where the optical fiber 110 contacts the first surface 102 of the substrate 100 and the material of the substrate 100 is melted and diffused into the material of the optical fiber 110. The bond areas 112, which are formed by the application of a laser beam, weld the optical fiber 110 to the first surface 102. It is noted that, in some embodiments, heating of a contact area 113 (FIG. 2) between optical fiber 110 and the first surface 102 of the substrate 100 may be provided by application of electromagnetic energy (e.g., microwaves) rather than a laser beam.

Any number of bond areas 112 may be provided along the length of the optical fiber 110. Bonding the optical fibers 110 to the surface of the substrate 100 may eliminate the need for organic materials, such as epoxy, to secure the optical fibers 110 to the substrate 100. Therefore, the assembly of the substrate 100 and the optical fibers 110 may be subjected to elevated temperatures of a solder reflow process without movement of the optical fibers 110 due to the presence of high CTE epoxy or other high CTE material.

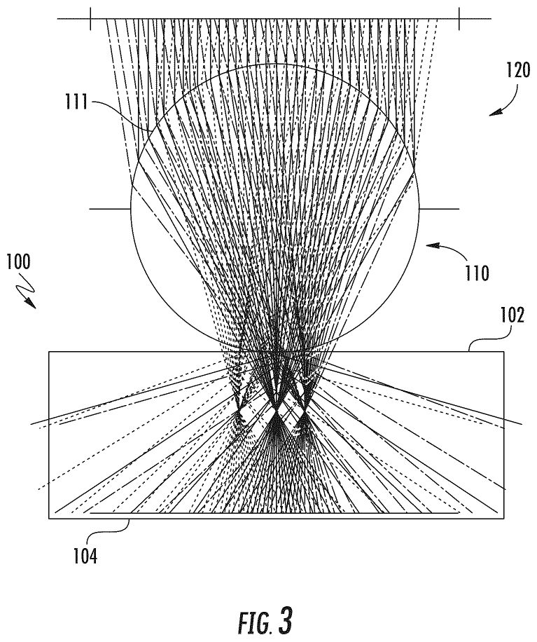

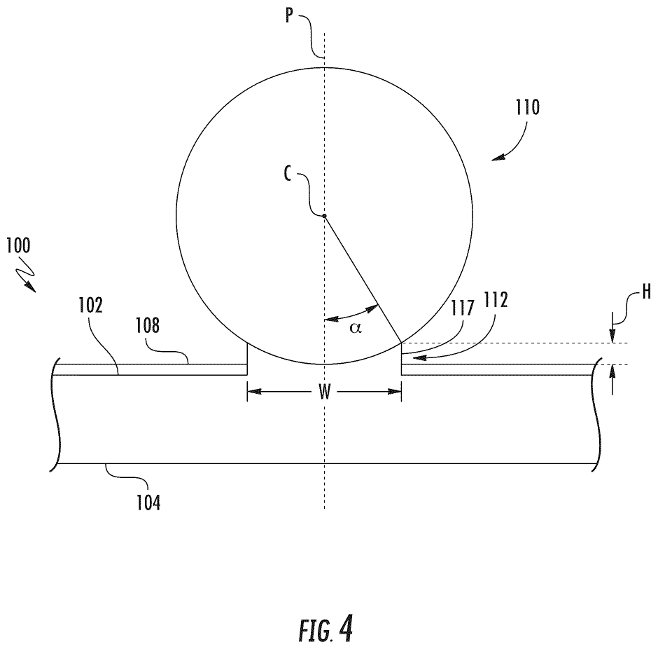

Referring now to FIGS. 2-5, an example process for laser welding optical fibers 110 to a substrate 100 is schematically illustrated. Referring first to FIG. 2, an end view of an optical fiber 110 disposed on a substrate 100 is schematically depicted. A film layer 108 is deposited on the first surface 102 (or the second surface 104). The film layer 108 is configured to absorb the laser beam, and raise the temperature of the first surface 102 to locally heat and melt the substrate 100, as described in more detail below and illustrated in FIGS. 3 and 4. The material of the film layer 108 should be chosen such that it is absorptive to the wavelength of the laser beam. As a non-limiting example, the film layer 108 should have an absorbance of greater than or equal to 20% as measured by reflectance and transmission of the sample. The absorbance is calculated as 100% minus the transmission value minus the reflectance value.

The thickness of the film layer 108 is not limited by this disclosure. It is noted that the thickness of the film layer 108 is exaggerated in FIGS. 2 and 4 for illustrative purposes. As a non-limiting example, the thickness of the film layer 108 is less than or equal to 1 μm. Non-limiting materials for the film layer 108 include metals (e.g., stainless steel), glasses (e.g., low melting glass (LMG)), ZnO, TiO₂, Nb₂O₅, an electromagnetic-absorbing oxide material, and an electromagnetic-absorbing nitride material among others. The material and thickness of the film layer 108 should be such that the material of the substrate 100 at the first surface 102 melts due to the absorption of the laser beam by the film layer 108.

Still referring to FIG. 2, an optical fiber 110 is disposed on the film layer 108 such that a contact area 113 is defined by contact between the optical fiber 110 and the film layer 108. The contact area 113 generally extends along the length of the optical fiber 110 that it is in contact with the film layer 108. It is noted that, in some embodiments, no film layer 108 is provided and the optical fiber(s) 110 is disposed directly on the first surface 102 (and/or second surface 104) of the substrate 100.

The optical fiber 110 has a curved surface, and has a generally circular shape. The shape of the optical fiber 110 enables the optical fiber 110 to act as a cylindrical lens that focuses an incident laser beam 120 at the contact area 113 without a complicated optical delivery system. Referring now to FIG. 3, the example optical fiber 110 of FIG. 2 is shown having a laser beam 120 passing therethrough. The incident laser beam 120 is weakly focused as it enters the optical fiber 110. The curved upper surface 111 of the optical fiber 110 that receives the laser beam 120 focuses the laser beam 120 such that a size (e.g., diameter) of the laser beam 120 at the contact area 113 is smaller than a size of the laser beam 120 as the laser beam 120 enters the optical fiber 110 (i.e., at the upper surface 111 of the optical fiber 110). It is noted that the different line types depicting the ray-tracing of the laser beam 120 correspond to different input angles of the coherent laser beam due to the numerical aperture of the focusing lens (not shown). Thus, FIG. 3 schematically depicts how the optical fiber 110 acts as a cylindrical lens that focuses the laser beam, thereby reducing the size of the laser beam at the contact area 113 without the need for complicated optics. The reduction in size of the laser beam causes the film layer 108 to be heated quickly and provide the formation of a bond area proximate the contact area 113.

The properties of the laser beam 120 should be such that the laser beam melts the material of the substrate 100 at the contact area 113, thereby causing diffusion between the material of the optical fiber 110 and the material of the substrate 100. The laser beam may be a continuous wave (CW) or quasi CW laser beam (i.e., a pulsed laser beam having a high repetition rate). The wavelength of the laser beam 120 should be such that the laser beam 120 is absorbed by the film layer 108 to melt the material of the substrate 100. For example, the wavelength of the laser beam 120 may be in the visible, ultraviolet or near infrared spectral bands. As a non-limiting example, the wavelength of the laser beam 120 may be within a range of 0.3 to 1.7 μm, including endpoints.

As a non-limiting example, the power of the laser beam 120 may be in a range of 0.5 W to 10 W including endpoints, and be single mode for focusing by the optical fiber 110. The diameter of the laser beam 120 at the upper surface 111 of the optical fiber 110 should be equal to or less than the diameter of the optical fiber 110, such as, without limitation between the diameter of the optical fiber 80 μm and 400 μm, including endpoints. The duration of time that the laser beam 120 is focused by the optical fiber 110 should be long enough to melt the material of the substrate 100 and to form a bond between the optical fiber 110 and the substrate 100.

As noted above, in some embodiments, no film layer is utilized to absorb the laser beam. In such embodiments, a high-power sub-picosecond pulsed laser is used without an absorbing film layer. The high-energy pulses melt the material of the substrate 100 without a need for the absorbing film layer. Due to the material non-linearity and multiphoton absorption process, absorption occurs without an absorbing film. Non-limiting example power values of a sub-picosecond pulsed laser include a power density more than 0.5 GW/cm² with an average power of greater than 200 mW.

FIG. 4 schematically depicts the optical fiber 110 after it is laser welded to the first surface 102 of the substrate 100 by the laser beam 120. Particularly, FIG. 4 depicts the topography of a bond area 112 that bonds the optical fiber 110 to the substrate 100. The film layer 108 absorbs the laser beam 120, which creates heat that causes the material of the substrate 100 to melt at the contact area 113. The melted material of the substrate 100 diffuses into the optical fiber 110, and also flows up toward the optical fiber 110, thereby forming a bond area 112 having a height H as measured from the surface of the film layer 108 (or the first surface 102 of the substrate 100) to an edge 117 of the bond area 112 that contacts the optical fiber 110. The height H of the bond area 112 is not limited by this disclosure. As an example and not a limitation, the height H of the bond area 112 may be from 0.2 to 10 μm.

The width W of the bond area 112 is dependent on the diameter of the laser beam 120 after the laser beam 120 is focused by the optical fiber 110. Additionally, an angle α is defined between a plane P through a center C of the optical fiber 110 and an edge 117 of the bond area 112. The value of the angle α depends on the height H and the diameter of the optical fiber. As a non-limiting example, for a range of the height H from 0.2 μm to 10 μm and a range of optical fiber diameter from 80 μm to 400 μm, the range of α is from 2.6 degrees to 40 degrees.

As shown in FIG. 4, the bond area 112 is a region of expanded glass that creates a “V-groove” matching the shape of the optical fiber 110 and providing significant contact area with the optical fiber 110. This contact area increases the bonding strength of the optical fiber 110 to the first surface 102 of the substrate 100.

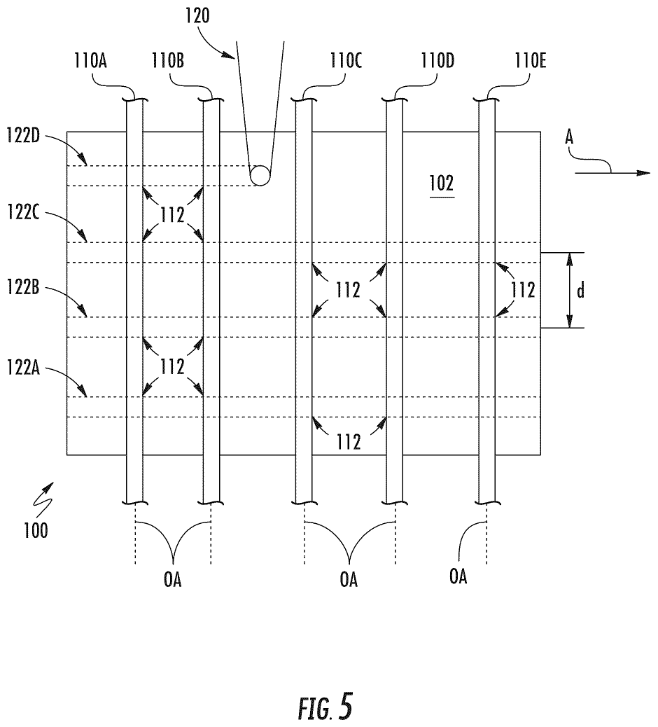

Multiple optical fibers 110 may be sequentially welded to the first surface 102 (and/or the second surface 104) of the substrate 100 to increase bonding strength. FIG. 5 schematically depicts a top-down view of optical fibers 110A-110E disposed on a first surface 102 of a substrate 100. The laser beam 120 is moved relative to the optical fiber 110A-110E in a direction A that is transverse to an optical axis OA of the optical fibers 110A-110E. In the example of FIG. 5, the direction A of the laser beam 120 is perpendicular to the optical axis OA of the optical fibers 110A-110E. However, embodiments are not limited thereto. It is noted that the laser beam 120 may be translated relative to the substrate 100, or the substrate 100 may be translated relative to the laser beam 120.

The laser beam 120 sequentially traverses and welds multiple optical fibers 110A-110E as it travels along direction A in a first pass 122A. As the laser beam 120 enters an optical fiber 110A-110E, it is focused as described above and creates a bond area 112. In some embodiments the material of the substrate 100 outside of the contact areas between the optical fibers 110A-110E and the substrate 100 is not melted by the laser beam 120. Rather, material is only melted at the contact areas (e.g., contact area 113 as shown in FIG. 2) because of the focusing effect of the optical fibers 110A-110E on the laser beam 120.

As shown in FIG. 5, multiple passes 122A-122D of the laser beam 120 may be performed to weld the optical fibers 110A-110E to the substrate 100 at multiple bond areas 112 along the length of the optical fibers 110A-110E. For example, a position of the laser beam 120 may be shifted by a distance d in a direction parallel to the optical axis OA of the optical fibers 110A-110E after completion of a pass to perform a subsequent pass. The distance d is not limited by this disclosure, and may depend on the desired number of bond areas 112 desired for each optical fiber 110A-110E. In FIG. 5, a fourth pass 122D is not yet complete as the laser beam 120 approaches a third optical fiber 110C. As a non-limiting example, the translation speed of the laser beam 120 with respect to the substrate 100 is in the range of 5 mm/s to 200 mm/s, including endpoints.

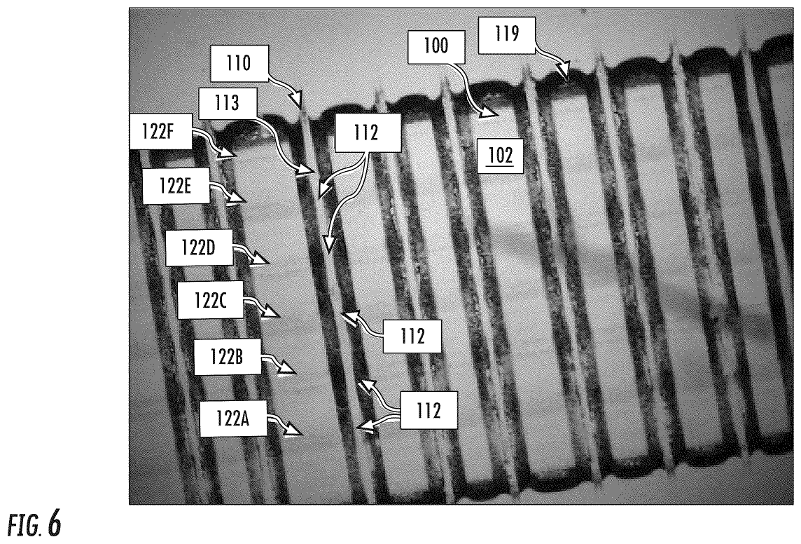

Referring now to FIG. 6, a microscope image of a plurality of optical fibers 110 bonded to a first surface 102 of a substrate 100 is provided. It is noted that the dark regions 119 of the image is index matching fluid. The microscope image of FIG. 6 was taken by disposing the index matching fluid on the first surface 102 of the substrate 100 and then placing a glass substrate on top of the optical fibers 110 such that the optical fibers 110 and the index matching fluid was disposed between the substrate 100 and the glass substrate. In this manner, the optical fibers 110 and their contact areas 113 become visible in the microscope image.

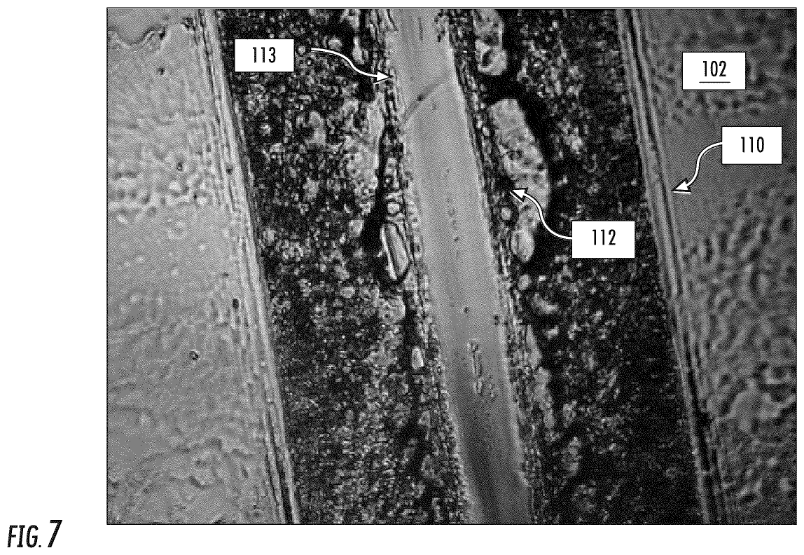

The substrate 100 shown in FIG. 6 is a 0.7 mm thick Corning® Eagle XG® glass substrate manufactured and sold by Corning Incorporated. The optical fibers 110 are Corning® SMF-28® optical fibers. A 20 nm thick stainless steel film layer is disposed on the first surface 102 of the substrate 100 to absorb the laser beam. The laser beam used to weld the optical fibers was a TEM 00 mode 355 nm wavelength laser beam having a power of 2.5 W and translated at a speed of 15 mm/s. Six passes 122A-122F of the laser beam were performed. The darker lines in the image show the path of the six passes 122A-122F. The distance between individual passes 122A-122F was about 0.2 mm. The laser beam 122 welds the optical fibers 110 to the first surface 102 at the bond areas 112. It is noted that not all of the bond areas 112 are labeled in FIG. 6 for ease of illustration. FIG. 7 depicts a close-up microscope image depicting an individual bond area 112. FIG. 7 shows that there is minimal damage to the optical fiber 110 or the substrate 100 at the bond area.

In another example, a 1550-nm single-mode CW laser was used to weld the Corning® SMF-28® optical fibers to the Eagle XG® substrate with the 6 W laser power and 120 mm/s beam scanning speed.

The resulting bonds of the optical fibers 110 to the substrate 100 in the example depicted in FIGS. 6 and 7 are strong. FIG. 8 is a close-up microscope image of optical fibers having broken ends 115 that were broken by lifting the optical fibers off of the substrate 100. Rather than being lifted at the bond areas 112 where the optical fibers 110 are bonded to the first surface 102 of the substrate 100, the optical fibers 110 were broken along their length, which is indicative of the bonding strength of the laser processes described herein.

Additionally, it was found that vertical displacement of the bottom of the optical fibers 110 at the bond areas was minimal. A Zygo interferometer was used to measure the surface topography of the substrate 100 under the optical fibers 110 as well as the bottoms of the optical fibers 110. Based on the analysis, the displacement of the bottoms of the optical fibers 110 is less than 0.2 μm at the bond areas. Thus, the optical fibers 110 remain in substantially the same position after laser welding as before laser welding. Accordingly, the process will lead to increased optical coupling between the optical fibers 110 of the fiber optic connector 201 (FIG. 11) and waveguides (not shown) to which the optical fibers 110 are connected because the optical fibers 110 are not vertically displaced after welding.

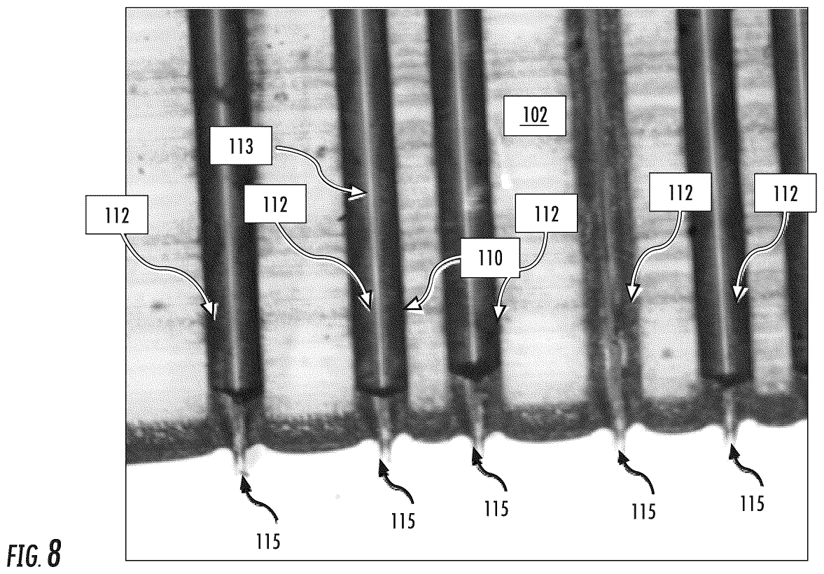

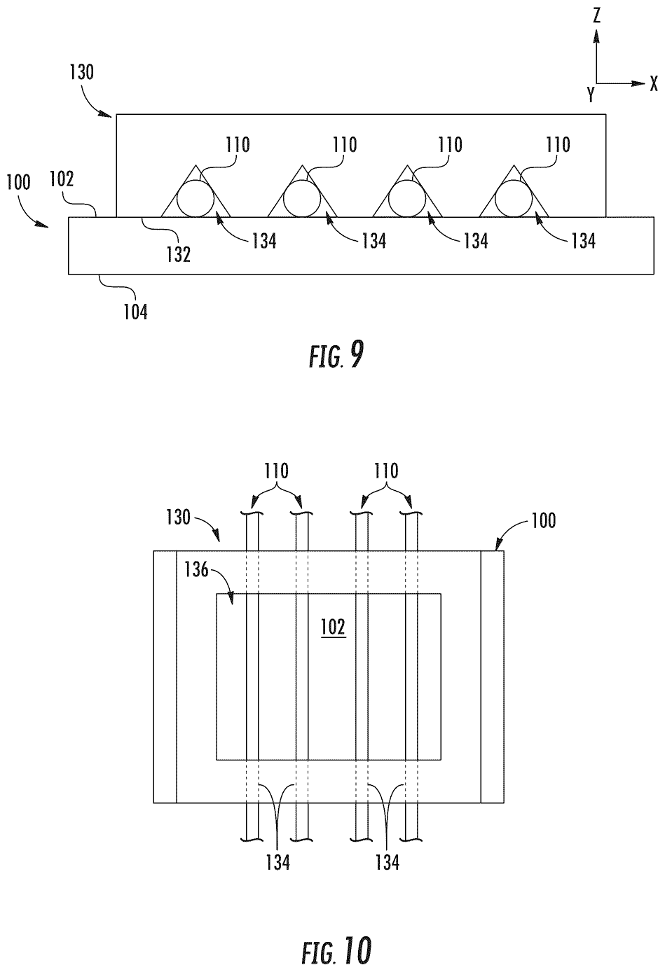

Referring now to FIGS. 9 and 10, an example, non-limiting fixture utilized to maintain the optical fibers in desired positions before the laser welding process. FIG. 9 is an end view of an assembly comprising a substrate 100, a plurality of optical fibers 110, and a fixture 130. FIG. 10 is a top-down view of the assembly depicted in FIG. 9. The fixture 130 may be fabricated from any suitable material, such as glass, metal or polymers, for example.

As shown in FIG. 9, the fixture has a bottom surface 132 having a plurality of grooves 134. The fixture 130 is disposed on the substrate 100 such that the bottom surface 132 of the fixture 130 contacts (or nearly contacts) the first surface 102 (and/or the second surface) or any film layers that are disposed on the first surface 102. The plurality of optical fibers 110 are positioned within the plurality of grooves 134. The plurality of grooves 134 of the fixture 130 position the plurality of optical fibers 110 at known locations on the x- and z-axis. As a non-limiting example, the precise placement of the fixture 130 on the substrate 100 may be performed by an active alignment process. Once in place, the fixture 130 may be mechanically clamped or otherwise secured to the substrate 100.

Referring now to FIG. 10, the fixture 130 has an open region 136 that exposes the optical fibers 110. The plurality of grooves 134 are interrupted by the open region 136. Thus, the laser beam 120 may be translated across the exposed optical fibers 110 to weld the optical fibers 110 to the substrate 100. As shown in FIG. 5, multiple passes of the laser beam 120 may be provided in the open region 136 to bond the optical fibers 110 to the substrate at multiple bond areas. After the optical fibers are bonded to the substrate 100, the fixture 130 may be removed from the substrate 100 and the assembly may be further processed.

Additional information regarding laser bonding optical elements such as optical fibers to a substrate is provided by U.S. Pat. Nos. 10,345,533, 10,422,961, 10,545,293, and 10,746,937, which are hereby incorporated by reference in their entireties.

As stated above, forces applied to the optical fibers 110 may cause the bond area 112 to fracture and fail. In cases where epoxy is used to further secure the optical fibers to the substrate or package the optical fibers and substrate into a connector housing, thermally induced stress due to the high coefficient of thermal expansion of the epoxy relative to the optical fibers 110 and the substrate 100 can apply forces to the optical fibers 110 leading to breakage.

Referring now to FIG. 12A, is optical fiber 110 bonded to a substrate 100 by a bond area 112 that has failed is illustrated by a scanning electron microscope (SEM) image. A fracture 116 is present within the bond area 112, which has caused the bond to fail between the optical fiber 110 and the substrate 100. The fracture 116 was caused by repeated thermal cycling with epoxy applied to the optical fiber 110 in the substrate 100. In this example, the substrate 100 was an Eagle XG® glass substrate. The Eagle XG® substrate was prepared by depositing an 80 nm thick stainless steel (SS) film on the clean 5 mm×17 mm surface, and plasma treating the surface with a handheld air-plasma source. The optical fibers from a stripped ribbon-fiber array were placed on the Eagle XG® substrate, a glass V-groove was temporarily brought down to hold the fibers with a proper pitch, and a 1060 nm focused laser (2 W<power<5 W) swept over the optical fibers to bond to bottoms of the optical fibers onto the Eagle XG® surface.

For comparison, FIG. 12B is a SEM image of an optical fiber bonded to the substrate 100 by a bond area 112 that has not fractured.

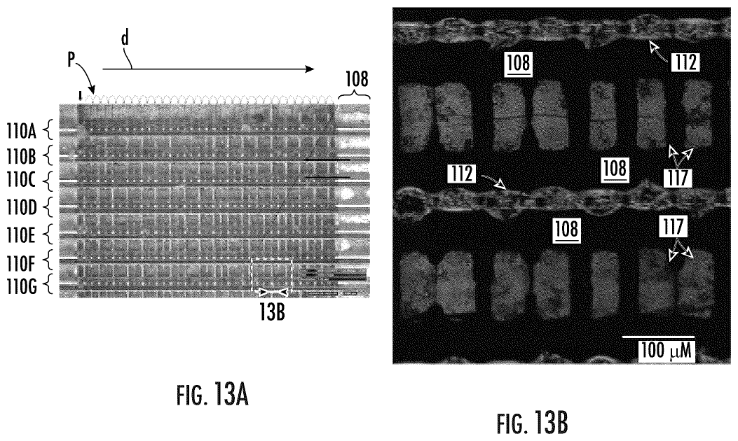

FIG. 13A is a top-down image of the plurality of optical fibers 110A-110G that are bonded to a substrate 100. The image was taken in reflection. Prior to laser bonding the plurality of optical fibers 110A-110G to the substrate 100, a metal film 108 was applied to the surface of the substrate 100. The laser used to bond the plurality of optical fibers 110A-110G to the substrate 100 was provided in a serpentine path P in a direction d. A portion of the metal film 108 remained at the edge of the substrate 100 as well as between individual optical fibers 110A-110G. FIG. 13B is a high resolution image of the area indicated 13B and FIG. 13A. FIG. 13B was taken in bright-field to more precisely reveal which regions are metallic and which ones are not because the light source illuminates the assembly from below and the image was taken from above.

In the image of FIG. 13B, the laser welded bond area 112 is a continuous translucent line evidencing that there is no metal between the optical fiber 110 and the substrate 100. The dark areas adjacent to the bond area 112 are metal regions provided by the metal film 108. Thus, continuous metal areas are adjacent to the bond areas 112. The lightly colored rectangular areas 117 are areas where the laser beam has ablated the metal film 108.

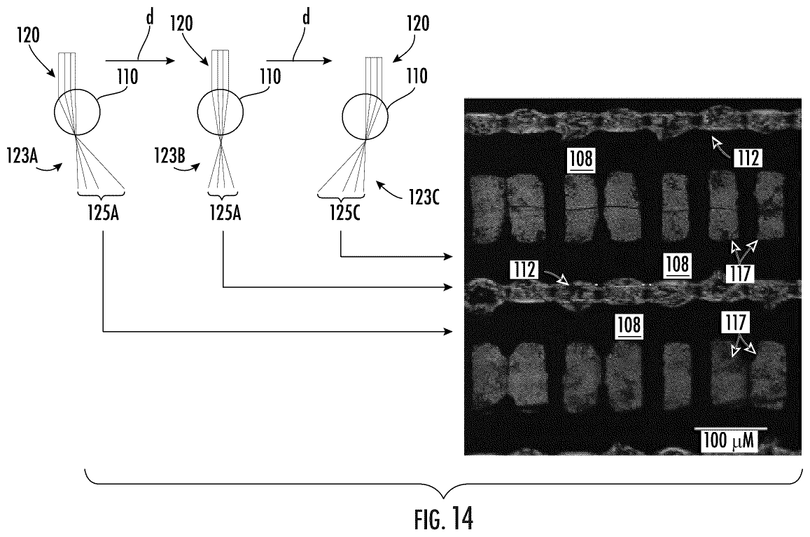

FIG. 14 illustrates laser-fiber interactions that cause the bond areas 112 and the metal regions of remaining metal film 108. A laser beam is swept in a direction d over an optical fiber 110. Interactions 123A, 123B and 123C provide optical ray tracing that illustrate three basic laser-fiber interactions revealing the origin of the intact metal directly underneath each optical fiber 110 in the optical fiber's peripheral regions. In interaction 123A the laser beam 120 passes into the optical fiber 110 at a left side that acts like a lens and provides a dissipated energy region 125A. The energy region is the amount of energy provided by the laser beam 120 divided by the area of incidents on the metal film 108. Interaction 123B shows that the laser beam 120 is focused directly underneath the optical fiber 110, which effectively serves as a cylindrical lens, to provide maximum focused energy per unit area in a focused energy region 125B, generating the temperatures sufficient to create the laser bond area 112. Interaction 123C is a mirror of interaction 123A and also provides a dissipated energy region 125C. Because dissipated energy regions 125A and 125C are smaller than focused energy region 125B, the temperatures at these locations are lower and therefore the metal film 108 is not ablated in these areas as shown in FIG. 14. It is noted that the power of the laser beam 120 is sufficient enough to ablate the metal film 108 in between optical fibers 110 as evidenced by rectangular areas 117.

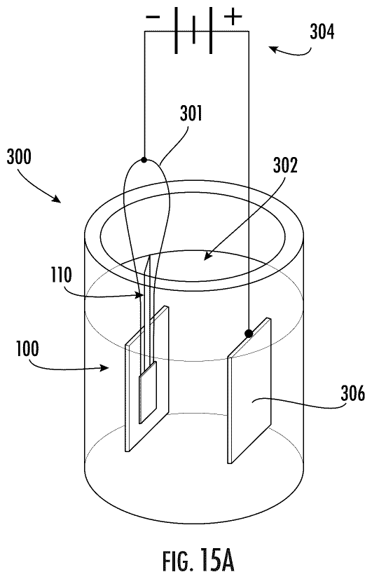

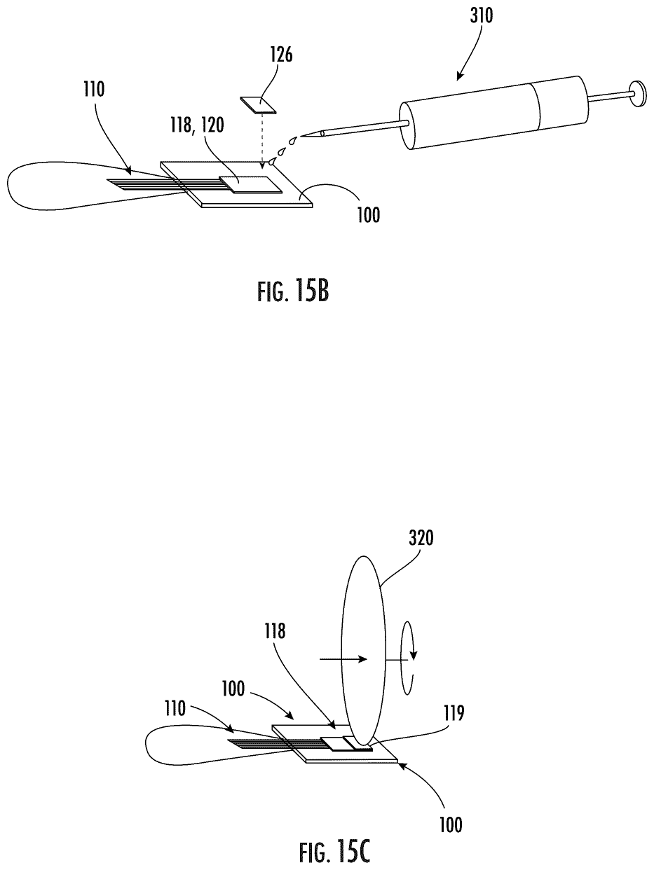

In embodiments of the present disclosure, the fact that the metal film 108 remains adjacent to the bond areas 112 and the optical fibers 110 is leveraged to create buttress structures that increase the strength of the bond areas 112 by minimizing the amount of torque that can be applied to the optical fibers 110 due to applied forces. The buttress structures are fabricated by electroplating a metal or metal alloy onto the metal film 108 adjacent to the bond areas 112. Referring now to FIG. 15A, a method of electroplating a substrate 100 having optical fibers 110 laser bonded thereto is schematically illustrated. An electroplating bath 300 including a solution 302 having metal ions is prepared. The metal chosen should have a relatively low coefficient of thermal expansion. In one nonlimiting example, nickel is used to electroplate the substrate 100. Therefore nickel ions are provided within the solution 302. The assembly comprising the optical fibers 110 that are bonded to the substrate 100 is submerged within the solution 302 of the electroplating bath 300. A conductor 301 is applied to the metal film on the substrate 100 such that the conductor 301 is electrically coupled to the metal film on the substrate 100. Additionally, an electrode 306 is submerged within the solution 302 of the electroplating bath 300. A voltage source 304 is electrically coupled to both the conductor 301 and the electrode 306. In the illustrated example, the positive terminal of the voltage source 304 is electrically coupled to the electrode 306 and the negative terminal of the voltage source 304 is electrically coupled to the conductor 301.

Electric current is provided by the voltage source 304 through the conductor 301, the metal film on the substrate 100, and the electrode 306. As a nonlimiting example, a sample substrate 100 was electroplate it using a DC current of 65 mA with a gentle stirring for 30 minutes. The solution 302 was a simple nickel solution. The electroplating rate was measured at 17 μm Ni-plate per 30 minutes.

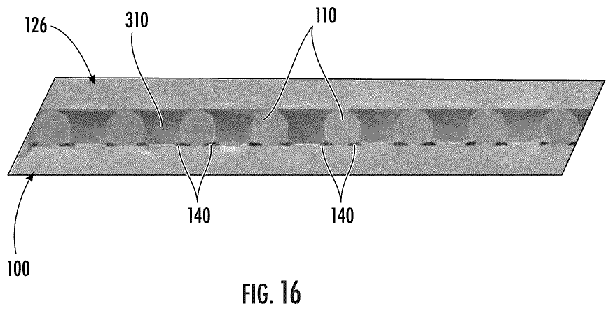

FIG. 15B illustrates further processing steps to assemble the package for use in an optical connector. The electroplating substrate 100 having buttress structures (described in more detail below) has a cover 126 applied to the tops of the optical fibers 110 and the bond areas 118 using an epoxy 310. The cover 126 may be fabricated from glass to maintain a coefficient of thermal expansion match between the cover 126, the optical fibers 110, and the substrate 100. FIG. 15C illustrates how an edge of the substrate 100 may be diced by a dicing wheel 320 to provide a smooth, cleaved edge for the optical fibers 110. FIG. 16 is an image that illustrates a diced edge face of the substrate 100, a plurality of optical fibers 110, and the cover 126. Disposed between the cover 126 and the substrate 100 are the plurality of optical fibers 110, the epoxy 310 and buttress structures 140 that are formed between the plurality of optical fibers 110 and the substrate 100. The buttress structures 140 are formed from one or more electroplated layers.

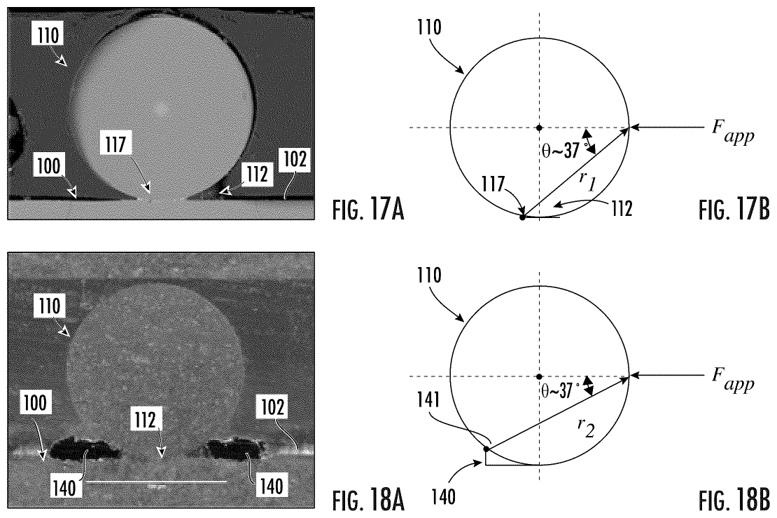

FIGS. 17A, 17B, 18A, and 18B illustrate how the buttress structures 140 reduce the amount of torque on the optical fibers 110. FIG. 17A is a SEM image illustrating an optical fiber 110 with no buttress structure applied adjacent to the bond area 112. FIG. 17B is a schematic illustration of the axis of rotation on the original laser-bonded optical fiber 110 against an applied load Fₐₚₚ indicated as being applied from the right. A lever arm r₁ is measured from the point on the optical fiber 110 where the force Fₐₚₚ is applied to an edge 117 of the bond area 112 that defines the axis of rotation (i.e., the edge of the bond area 112 that contacts the optical fiber 110). The axis of rotation may be located using image processing software. It is noted that the image analysis tool Image) was used to extract the lever-arm angular and length parameters from the images shown in FIGS. 17A and 18A. The optical fiber 110 has a diameter of 125 μm. The lever arm r₁ is measured to be about 102 μm. The lever arm r₁ defines an angle θ₁ with respect to a horizontal central plane of the optical fiber 110 (i.e., a plane parallel to the first surface 102 of the substrate 100) that is about 37°. The torque τ_{w} in this example is calculated as about 61 μm·Fₐₚₚ.

FIG. 18A is a close-up view of one of the optical fibers 110 shown in FIG. 16. There are buttress structures 140 fabricated from electroplated nickel adjacent the bond area 112 and below the bottom of the optical fiber 110. FIG. 18B is a schematic illustration of the axis of rotation on the original laser-bonded optical fiber 110 against an applied load Fₐₚₚ indicated as where the force Fₐₚₚ is applied to an edge 141 of the buttress structure 140 where the optical fiber 110 contacts the buttress structure 140 (which defines the axis of rotation). The lever arm r₂ is measured to be about 102 μm. The lever arm r₂ defines an angle θ₂ with respect to a horizontal central axis of the optical fiber 110 that is about 23°. The torque z w in this example is calculated as about 40 μm Fₐₚₚ.

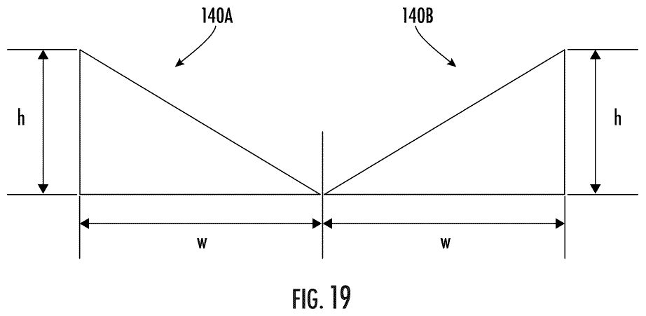

The welded regions of the original laser-bonded optical fibers (FIG. 17A) are modeled as comprised of two shallow right-triangles joined at the tips (width is about 15 μm, and height is about 2 μm) at center, with the axis of rotation located at their peripheral height. That is 15 μm left of center, at a height of 2 μm. This is contrasted with the welded regions of the buttressed laser-bonded optical fibers having buttress structures 140 of FIG. 18A, with right-triangle dimensions (width about 52 μm, and height about 14 μm) and an axis of rotation located 52 μm left of center, at a height of 14 μm. A schematic view of first and second buttress structures 140A, 140B is illustrated by FIG. 19. The torque reduction in using the metal-buttressed structure instead of the simple weld structure is (τ_{w}/τₘ), or about one-third, using the geometry shown in FIGS. 17B and 18B. The size of the buttress structure is adjustable by varying the plating duration to the desired level of torque reduction.

By increasing the length of the lever arm, a ratio of the radius of the optical fiber to the length of the lever arm is reduced. As a non-limiting example, the metal buttress structure 140 may provide a ratio of a radius of the optical fiber 110 to a lever arm length that is less than 0.6. The larger the buttress structures 140 adjacent the optical fiber 110, the stronger the weld. As a non-limiting example, the buttress structures 140 may have a maximum width w (as measured from a plane perpendicular to the center axis of the optical fiber to a furthest point of the buttress structure) that is equal to the radius of the optical fiber 110 and a minimum width w that is equal to 30% of the radius of the optical fiber 110. Additionally, the buttress structures 140 may have a maximum height h that is equal to the radius of the optical fiber 110 and a minimum height h that is equal to 25% of the radius of the optical fiber 110.

The buttress structures 140 reduce the amount of torque experienced by the optical fibers 110. Reliability studies suggest most fracturing of laser-bonded optical fibers originate at the outer edges of the laser bond region. For example, the periphery of bond area 112 of FIG. 17A would exhibit a greater likelihood of fracturing in these two peripheral wing locations after a few thousand thermal cycles between about 40° C. and about 85° C. The cured epoxy used to form the final package exhibits a small yet sufficient amount of thermal expansion, after repeated thermal cycles that occasionally initiates a fracture. However, the buttress structure 140 addresses this issue by providing a metal trough that cups the optical fiber along its length on either side of the laser bond region.

Embodiments are not limited by the type of material for the buttress structure. Nickel's coefficient of thermal expansion (CTE) is about 13 ppm/° C. However, Invar having CTE of about 1.2 ppm/° C. should significantly enhance the reliability further, possibly opening rugged operation at extremely cold temperatures suitable for Quantum computing.

Embodiments are also not limited optical fibers having a diameter of 125 μm. Optical fibers may have larger or smaller diameters in other embodiments. Further, as mentioned above, other embodiments may comprise optical elements other than optical fibers.

For the purposes of describing and defining the present invention it is noted that the terms “approximately” and “substantially” are utilized herein to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising”.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

1. An assembly comprising:
a substrate comprising a surface;
an optical element bonded to the surface of the substrate;
a bond area between the optical element and the surface of the substrate, wherein the bond area comprises laser-melted material of the substrate that bonds the optical element to the substrate; and
a metal buttress structure adjacent to the bond area and the optical element.

2. The assembly of claim 1, wherein the metal buttress structure comprises an electroplated layer.

3. The assembly of claim 1, wherein the metal buttress structure has a coefficient of thermal expansion that is less than 20 ppm/° C.

4. The assembly of claim 1, wherein the metal buttress structure is fabricated from Invar.

5. The assembly of claim 1, wherein the optical element comprises an optical fiber.

6. The assembly of claim 5, wherein the metal buttress structure has a height that is at least 25% of a radius of the optical fiber.

7. The assembly of claim 5, wherein the metal buttress structure provides a ratio of a radius of the optical fiber to a lever arm length provided by the metal buttress structure that is less than 0.6.

8. The assembly of claim 1, wherein the metal buttress structure and the bond area extend along at least a portion of a length of the optical fiber.

9. The assembly of claim 1, wherein the metal buttress structure has a width that is greater than or equal to 10 μm and a height that is greater than or equal to 1.5 μm.

10. The assembly of claim 1, further comprising one or more additional optical elements bonded to the surface of the substrate.

11. A fiber optic connector comprising:
a housing;
a substrate disposed within the housing, the substrate comprising a surface;
a film layer;
an array of optical fibers bonded to the surface of the substrate;
a bond area between each optical fiber of the array of optical fibers and the surface of the substrate, wherein the bond area comprises laser-melted material of at least one of the substrate and film layer that bonds the optical fiber to the substrate; and
a metal buttress structure adjacent to each bond area and each optical fiber of the array of optical fibers.

12. The fiber optic connector of claim 11, wherein the metal buttress structure comprises an electroplated layer.

13. The fiber optic connector of claim 11, wherein the metal buttress structure has a coefficient of thermal expansion that is less than 20 ppm/° C.

14. The fiber optic connector of claim 11, wherein the metal buttress structure is fabricated from Invar.

15. The fiber optic connector of claim 11, wherein the metal buttress structure height that is at least 25% of a radius of the optical fibers.

16. The fiber optic connector of claim 11, wherein the metal buttress structure provides a ratio of a radius of the optical fibers to a lever arm length provided by the metal buttress structure that is less than 0.6.

17. The fiber optic connector of claim 11, wherein the metal buttress structure has a width that is greater than or equal to 10 μm and a height that is greater than or equal to 1.5 μm.

18. The fiber optic connector of claim 11, wherein the metal buttress structure and the bond area extend along at least a portion of a length of the optical fibers.

19. A method of bonding an optical element to a substrate, the method comprising:
disposing a film layer on a surface of the substrate;
disposing the optical element on a surface of the film layer;
directing a laser beam into the optical element;
melting, using the laser beam that was directed into the optical element, a material of the substrate to create a bond area between the optical element and the surface of the substrate, wherein the film layer is capable of absorbing a wavelength of the laser beam to melt at least one of the material of the substrate and the film layer at the bond area, and the bond area comprises laser-melted material of the substrate that bonds the optical element to at least one of the substrate and the film layer; and
electroplating a metal buttress structure adjacent to the optical element.

20. The method of claim 19, wherein the optical element is an optical fiber, and the metal buttress structure provides a ratio of a radius of the optical fiber to a lever arm length provided by the metal buttress structure that is less than 0.6.
